(19) United States
(12) Patent Application Publication
(10) Pub. No.: US 2022/0205827 A1
(43) Pub. Date: Jun. 30, 2022

(54) PULSED RLG WITH IMPROVED RESISTANCE TO SIGNAL DISTURBANCE

(71) Applicant: Rosemount Tank Radar AB, Mölnlycke (SE)

(72) Inventors: Mikael Eriksson, Västervik (SE); Leif Nilsson, Linköping (SE); Håkan Nyberg, Linköping (SE)

(21) Appl. No.: 17/439,967

(22) PCT Filed: Apr. 26, 2019
(86) PCT No.: PCT/EP2019/060777

§ 371 Date: Sep. 16, 2021

(51) Int. Cl. G01F 23/284; G01S 13/22

(52) U.S. Cl. CPC G01F 23/2845; G01S 13/227

(57) ABSTRACT

A method of determining a filling level of a product in a tank, comprising, for each transmit pulse repetition frequency in a sequence of different transmit pulse repetition frequencies: generating and transmitting an electromagnetic transmit signal in the form of a pulse train of transmit pulses, the pulse train exhibiting the transmit pulse repetition frequency; propagating the transmit signal towards a surface of the product in the tank; returning an electromagnetic reflection signal resulting from reflection of the transmit signal at the surface back towards the transceiver; receiving the reflection signal; determining a measure indicative of signal disturbance of the reflection signal; evaluating the measure indicative of signal disturbance of the reflection signal in view of a predefined signal disturbance criterion; and determining the filling level based on at least one of the reflection signals fulfilling the signal disturbance criterion.

### TECHNICAL FIELD OF THE INVENTION

The present invention relates to a method of determining a filling level, and to a radar level gauge system.

### TECHNICAL BACKGROUND

Pulsed radar level gauging is a cost-efficient and convenient way of measuring the filling levels of tanks in many applications, for example in the process industry. In environments where pulsed radar level gauge systems are commonly used, there may be many other sources of electromagnetic signals, such as other pulsed radar level gauge systems. It has been found that the performance of a pulsed radar level gauge system may be degraded due to disturbance from other sources of electromagnetic signals. It would therefore be desirable to provide for improved pulsed radar level gauging, in particular pulsed radar level gauging that is more resistant to signal disturbance.

### SUMMARY

In view of the above, a general object of the present invention is to provide for improved pulsed radar level gauging, in particular pulsed radar level gauging that is more resistant to signal disturbance.

According to a first aspect of the present invention, it is therefore provided a method of determining a filling level of a product in a tank using a radar level gauge system including a transceiver, a signal propagation device and processing circuitry, the method comprising the steps of: performing, for each transmit pulse repetition frequency in a sequence of different transmit pulse repetition frequencies, a measurement operation including: generating and transmitting an electromagnetic transmit signal in the form of a pulse train of transmit pulses, the pulse train exhibiting the transmit pulse repetition frequency; propagating the transmit signal towards a surface of the product in the tank; returning an electromagnetic reflection signal resulting from reflection of the transmit signal at the surface back towards the transceiver; and receiving the reflection signal. The method further comprises the steps of determining, for each measurement operation, a measure indicative of signal disturbance of the reflection signal received in the measurement operation; evaluating, for each measurement operation, the measure indicative of signal disturbance of the reflection signal in view of a predefined signal disturbance criterion; and determining the filling level based on at least one of the reflection signals fulfilling the signal disturbance criterion.

The tank may be any container or vessel capable of containing a product, and may be metallic, or partly or completely non-metallic, open, semi-open, or closed. Furthermore, the filling level of the product in the tank may be determined directly by using a signal propagation device propagating the transmit signal towards the product inside the tank, or indirectly by using a propagation device disposed inside a so-called chamber located on the outside of the tank, but being in fluid connection with the inside of the tank in such a way that the level in the chamber corresponds to the level inside the tank.

The present invention is based on the realization that a convenient and effective way of handling external signal disturbances potentially affecting the performance of a pulsed radar level gauge system would be to perform measurements using several pulse repetition frequencies (PRFs), evaluate the measurements, and discarding disturbed measurements. Hereby, robust pulsed radar level gauging can be achieved without the need for monitoring or evaluating potentially disturbing signals etc. Furthermore, disturbance signals with different frequencies can be handled, by discarding different sets of measurements.

According to embodiments of the present invention, the sequence of different pulse repetition frequencies may include at least three different pulse repetition frequencies.

Furthermore, the different pulse repetition frequencies may differ from each other by at least 5%, advantageously at least 10%, to increase the probability of performing undisturbed measurement operations.

According to embodiments, each measurement operation may comprise generating a pulsed reference signal having a reference pulse repetition frequency.

The reference pulse repetition frequency may be different for different measurement operations.

According to embodiments, a difference between the transmit pulse repetition frequency and the reference pulse repetition frequency may be substantially the same for each of the measurement operations. While not being necessary, this may simplify the measurement operations and maximize the use of the available bandwidth of measurement electronics comprised in the radar level gauge system.

Furthermore, each measurement operation may comprise time-correlating the reference signal and the reflection signal to form a measurement signal.

For pulsed radar level gauge systems, time expansion techniques may be used to resolve the time-of-flight.

In such pulsed radar level gauge systems a transmit signal in the form of a first pulse train with a first pulse repetition frequency is propagated towards the surface of the product in the tank, and a surface reflection signal resulting from reflection at the surface is received.

A reference signal in the form of a second pulse train having a second pulse repetition frequency, controlled to differ from the first pulse repetition frequency by a given frequency difference, may also be generated.

At the beginning of a measurement operation, the transmit signal and the reference signal may be synchronized to have the same phase. Due to the difference in pulse repetition frequency, the phase difference between the transmit signal and the reference signal will gradually increase during the measurement operation.

During the measurement operation, the surface reflection signal may be time-correlated with the reference signal, to form a measurement signal based on a time correlation between the surface reflection signal and the reference signal. Based on the measurement signal, the filling level can be determined. According to one example, such time correlation may be achieved by sampling the surface reflection signal at sampling times determined by the timing of the reference pulses. For instance, the reference pulses may be used to trigger sampling circuitry coupled to the signal propagation device and configured to sample the reflection signal.

According to various embodiments of the present invention, the above-mentioned measure indicative of signal disturbance of the reflection signal received in the measurement operation may be determined based on the measurement signal formed in the measurement operation. This measurement signal may sometimes be referred to as an “echo curve”.

According to a second aspect of the present invention, it is provided a radar level gauge system for determining the filling level of a product in a tank, comprising: a transceiver for generating, transmitting and receiving electromagnetic signals; a propagation device coupled to the transceiver for propagating an electromagnetic transmit signal from the transceiver towards a surface of the product in the tank, and returning an electromagnetic reflection signal resulting from reflection of the transmit signal at the surface of the product; and processing circuitry coupled to the transceiver, and configured to: control the transceiver to perform, for each transmit pulse repetition frequency in a sequence of different transmit pulse repetition frequencies, a measurement operation including: generating and transmitting the transmit signal in the form of a pulse train of transmit pulses, the pulse train exhibiting the transmit pulse repetition frequency; and receiving the reflection signal; determine, for each measurement operation, a measure indicative of signal disturbance of the reflection signal received in the measurement operation; evaluate, for each measurement operation, the measure indicative of signal disturbance of the reflection signal in view of a predefined signal disturbance criterion; and determine the filling level based on at least one of the reflection signals fulfilling the signal disturbance criterion.

The “transceiver” may be one functional unit capable of transmitting and receiving electromagnetic signals or may be a system comprising separate transmitter and receiver units.

It should be noted that the processing circuitry may be provided as one device or several devices working together.

The propagation device may be a radiating antenna, or a probe extending towards and into the product in the tank. In embodiments where the propagation device is a probe, it should be understood that the probe is a waveguide designed for guiding electromagnetic signals. The probe may be rigid or flexible and may advantageously be made of metal, such as stainless steel.

According to embodiments, the transceiver may comprise a PLL (phase locked loop) circuit controllable to generate signals having the transmit pulse repetition frequency.

Further embodiments and variations of this second aspect of the present invention are largely analogous to those described above in respect of the first aspect of the invention.

In summary, the present invention thus relates to a method and system of determining a filling level of a product in a tank, the method comprising and the system being configured for, for each transmit pulse repetition frequency in a sequence of different transmit pulse repetition frequencies: generating and transmitting an electromagnetic transmit signal in the form of a pulse train of transmit pulses, the pulse train exhibiting the transmit pulse repetition frequency; propagating the transmit signal towards a surface of the product in the tank; returning an electromagnetic reflection signal resulting from reflection of the transmit signal at the surface back towards the transceiver; receiving the reflection signal; determining a measure indicative of signal disturbance of the reflection signal; evaluating the measure indicative of signal disturbance of the reflection signal in view of a predefined signal disturbance criterion; and determining the filling level based on at least one of the reflection signals fulfilling the signal disturbance criterion.

### BRIEF DESCRIPTION OF THE DRAWINGS

These and other aspects of the present invention will now be described in more detail, with reference to the appended drawings showing a currently preferred embodiment of the invention, wherein:

FIG. 1 schematically illustrates an exemplary tank arrangement comprising a radar level gauge system according to an embodiment of the present invention;

FIG. 2 is schematic illustration of the measurement unit comprised in the radar level gauge system in FIG. 1;

FIG. 3 is a schematic block diagram of the transceiver and measurement processor comprised in a radar level gauge system according to an embodiment of the present invention;

FIG. 4 is a flow-chart schematically illustrating example embodiments of the method according to the present invention;

FIG. 5 schematically illustrates examples of the transmit signal, the reflection signal and the reference signal;

FIGS. 6A-B are exemplary echo curves that conceptually illustrate different examples of signal disturbance criteria;

FIG. 7 is a conceptual illustration of an exemplary sequence of pulse repetition frequencies; and

FIG. 8 is a flow-chart schematically illustrating further example embodiments of the method according to the present invention.

### DETAILED DESCRIPTION OF EXAMPLE EMBODIMENTS OF THE INVENTION

In the present detailed description, various embodiments of the present invention are mainly discussed with reference to a pulsed radar level gauge system with a signal propagation device in the form of a probe, and wireless communication capabilities.

It should be noted that this by no means limits the scope of the present invention, which also covers a pulsed radar level gauge system with another type of signal propagation device, such as a radiating antenna, as well as a pulsed radar level gauge system configured for wired communication, for example using a 4-20 mA current loop and/or other wired means for communication.

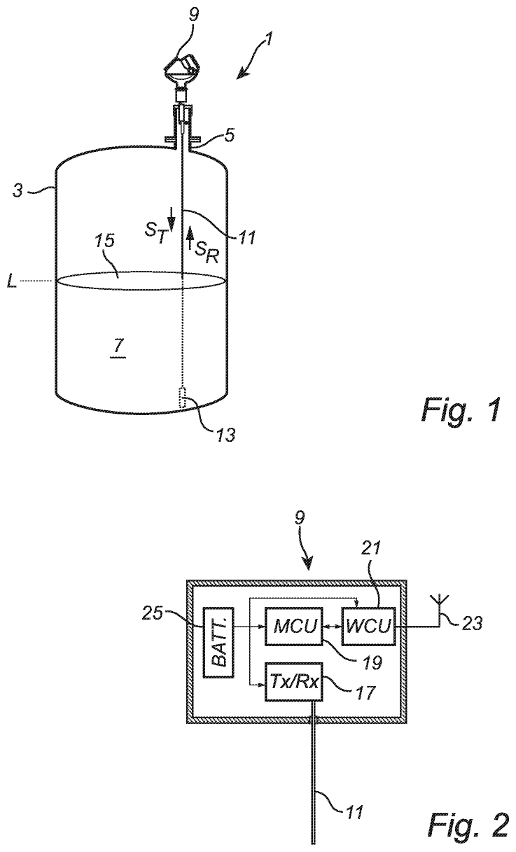

FIG. 1 schematically shows an exemplary radar level gauge system 1 of GWR (Guided Wave Radar) type installed at a tank 3 having a tubular mounting structure 5 (often referred to as a “nozzle”) extending substantially vertically from the roof of the tank 3.

The radar level gauge system 1 is installed to measure the filling level of a product 7 in the tank 3. The radar level gauge system 1 comprises a measuring unit 9 and a propagation device, here in the form of a single conductor probe 11 extending from the measuring unit 9, through the tubular mounting structure 5, towards and into the product 7. In the example embodiment in FIG. 1, the single conductor probe 11 is a wire probe, that has a weight 13 attached at the end thereof to keep the wire straight and vertical.

By analyzing a transmit signal S_{T} being guided by the probe 11 towards the surface 15 of the product 7, and a reflection signal S_{R} traveling back from the surface 15, the measurement unit 9 can determine the filling level L of the product 7 in the tank 3. It should be noted that, although a tank 3 containing a single product 7 is discussed herein, the distance to any material interface along the probe can be measured in a similar manner.

The radar level gauge system in FIG. 1 will now be described in more detail with reference to the schematic block diagram in FIG. 2.

Referring to the schematic block diagram in FIG. 2, the measurement unit 9 of the exemplary radar level gauge system 1 in FIG. 1 comprises a transceiver 17, a measurement control unit (MCU) 19, a wireless communication control unit (WCU) 21, a communication antenna 23, and an energy store, such as a battery 25.

As is schematically illustrated in FIG. 2, the MCU 19 controls the transceiver 17 to generate, transmit and receive electromagnetic signals. The transmitted signals pass through a feed-through to the probe 11, and the received signals pass from the probe 11 through the feed-through to the transceiver 17.

The MCU 19 determines the filling level L of the product 7 in the tank 3 and provides a value indicative of the filling level to an external device, such as a control center, from the MCU 19 via the WCU 21 through the communication antenna 23. The radar level gauge system 1 may advantageously be configured according to the so-called WirelessHART communication protocol (IEC 62591).

Although the measurement unit 9 is shown to comprise an energy store (battery 25) and to comprise devices (such as the WCU 21 and the communication antenna 23) for allowing wireless communication, it should be understood that power supply and communication may be provided in a different way, such as through communication lines (for example 4-20 mA lines).

The local energy store need not (only) comprise a battery, but may alternatively, or in combination, comprise a capacitor or super-capacitor.

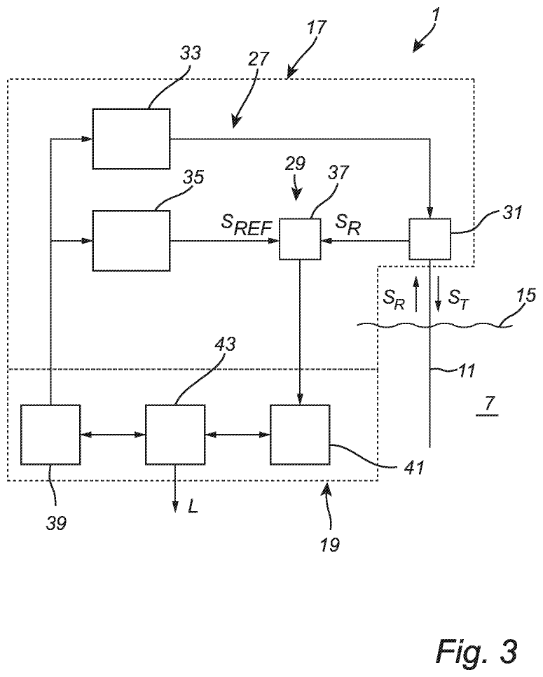

The radar level gauge system 1 in FIG. 1 will now be described in greater detail with reference to the schematic block diagram in FIG. 3.

As is schematically shown in FIG. 3, the transceiver 17 comprises a transmitter branch 27 for generating and transmitting a transmit signal S_{T} towards the surface 15 of the product 7 in the tank, and a receiver branch 29 for receiving and operating on the reflection signal S_{R} resulting from reflection of the transmit signal S_{T} at the surface 15 of the product 7. As is indicated in FIG. 3, the transmitter branch and the receiver branch are both connected to a directional coupler 31 to direct signals from the transmitter branch to the probe 11 and to direct reflected signals being returned by the probe 11 to the receiver branch.

The transceiver 17 comprises pulse generating circuitry, here in the form of a first pulse forming circuit 33 and a second pulse forming circuit 35. The transmit signal S_{T} is generated by the first pulse forming circuit 33, and a reference signal S_{REF} is generated by the second pulse forming circuit 35.

The transmitter branch 27 comprises the first pulse forming circuit 33, and the receiver branch 29 comprises the second pulse forming circuit 35 and measurement circuitry 37. As is, per se, well known in the art, the measurement circuitry may comprise a time-correlator, such as a sampler controlled to sample the reflection signal S_{R} at sampling times determined by the reference signal S_{REF}.

With continued reference to FIG. 3, the processing circuitry (MCU) 19 comprises a timing control unit 39, a signal disturbance evaluation unit 41, and a level determination unit 43. The timing control unit 39 is coupled to the transceiver 17 for controlling operation of the first pulse forming circuit 33 and the second pulse forming circuit 35. The signal disturbance evaluation unit 41 is coupled to the transceiver 17 for receiving a measurement signal S_{M} provided by the measurement circuitry 37. The level determination unit 43 determines the filling level based on input from at least the signal disturbance evaluation unit 41 and provides a value indicative of the filling level L.

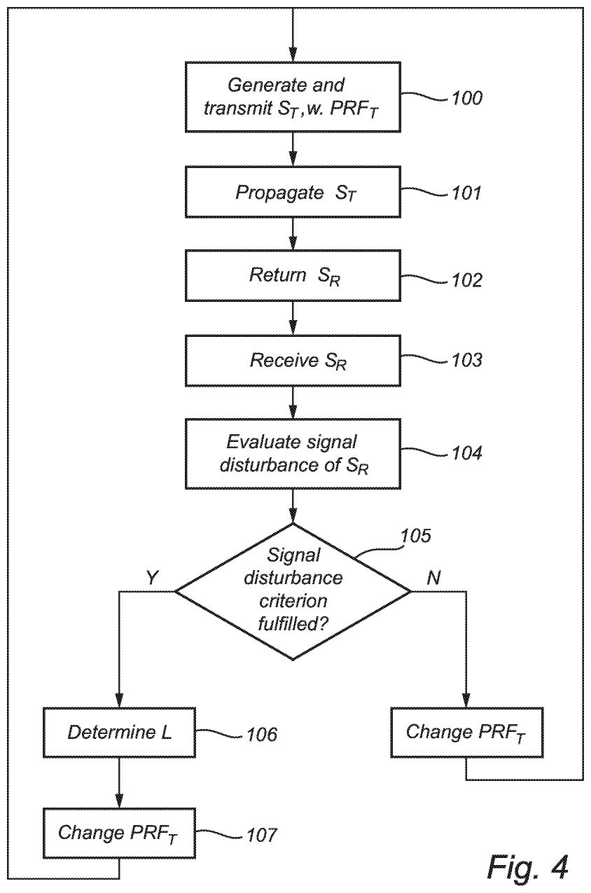

Embodiments of the method according to the present invention will now be described with reference to the flow-chart in FIG. 4. In a first sequence of steps 100-103, a measurement operation is performed for each transmit pulse repetition frequency PRF_{T} in a sequence of different transmit pulse repetition frequencies. In the first step 100, an electromagnetic transmit signal S_{T} is generated and transmitted, by the transceiver 17, in the form of a pulse train of transmit pulses, exhibiting the transmit pulse repetition frequency PRF_{T}. In the next step 101, the transmit signal S_{T} is propagated, by the signal propagation device 11, towards the surface 15 of the product 7 in the tank 3. In the subsequent step 102, an electromagnetic reflection signal S_{R} resulting from reflection of the transmit signal S_{T} at the surface 15 is returned by the signal propagation device 15 back towards the transceiver 17, and the transceiver 17 receives the reflection signal SR in step 103.

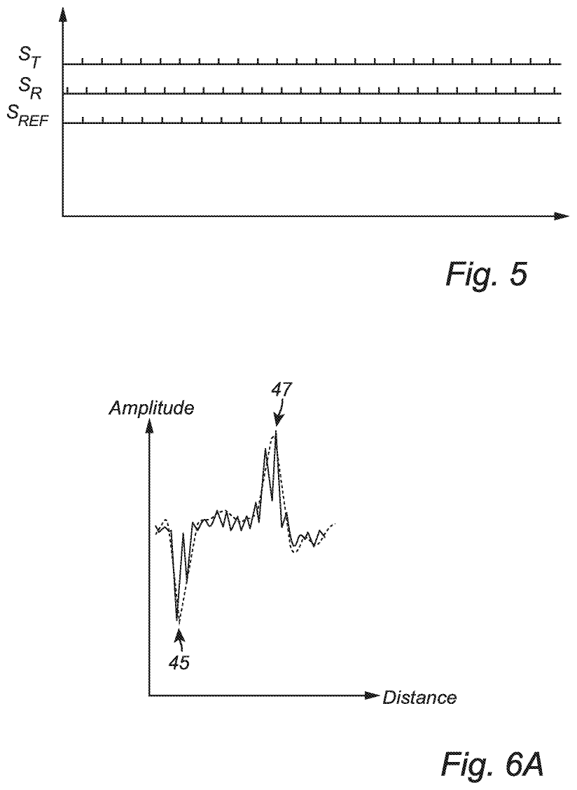

An example of the transmit signal S_{T} and an example of the resulting reflection signal S_{R} are schematically shown in FIG. 5 (the two signals at the top in the diagram in FIG. 5). As is indicated in FIG. 5, the transmit signal S_{T} and the reflection signal S_{R} have the same pulse repetition frequency (the transmit pulse repetition frequency PRF_{T}), but the reflection signal S_{R} is delayed from traveling along the probe 11 to the surface 15 of the product 7 and back.

Returning to the flow-chart in FIG. 4, the signal disturbance of the reflection signal S_{R} received during the present measurement operation (measurement operation n) is evaluated in step 104. During evaluation of the signal disturbance, a measure indicative of the signal disturbance of the reflection signal S_{R} is determined, and evaluated in view of a predefined signal disturbance criterion. The predefined signal disturbance criterion may be an absolute criterion, where the reflection signal S_{R} is considered to have fulfilled the criterion if certain predefined values are reached. Alternatively, the predefined signal disturbance criterion may be a relative criterion, where the reflection signal S_{R} with the highest score among a plurality of evaluated reflection signals is considered to have fulfilled the criterion. A combination of absolute and relative criteria may also be used. If, for example, one or several reflection signals fulfill(s) an absolute criterion that or those reflection signals can be considered to have fulfilled the predefined signal disturbance criterion. If, on the other hand, none of the evaluated reflection signals fulfills the absolute criterion, the relative criterion may be applied, so that the “best” reflection signal can be considered to have fulfilled the predefined signal disturbance criterion.

Furthermore, the reflection signal S_{R} may be evaluated in respect of the signal disturbance criterion directly or indirectly. In a direct evaluation, the noise level of the reflection signal S_{R} may be measured directly, and compared against a predefined signal disturbance criterion. In an indirect evaluation, another signal based on the reflection signal S_{R} may be evaluated. In embodiments, a time-expanded measurement signal S_{M} may advantageously be evaluated.

To form a time-expanded measurement signal S_{M}, a reference signal S_{REF} may optionally be generated in each measurement operation. The reference signal S_{REF} is a pulse train with a pulse repetition frequency that is controlled to differ from the transmit pulse repetition frequency PRF_{T} by a predetermined frequency difference Δf. When a measurement sweep starts, the reference signal S_{REF} and the transmit signal S_{T} are in phase, and then the time until the reference signal “catches up with” the reflected signal S_{R} is determined. Based on this time and the frequency difference Δf, the distance to the surface 15 can be determined. An example reference signal S_{R} is schematically illustrated as the third signal from the top in FIG. 5.

The time-expansion technique that was briefly described in the previous paragraph is well known to the person skilled in the art, and is widely used in pulsed radar level gauge systems.

The output from the measurement circuitry 37 in FIG. 3 may be a representation of the time-correlation between the reflection signal S_{R} and the reference signal S_{REF} (and thus with the transmit signal S_{T}) across the sweep, and may be provided to the signal disturbance evaluation unit 41 in the form of a so-called echo curve. The signal disturbance of the reflection signal S_{R} may be evaluated in step 105 by evaluating the echo curve of the measurement operation.

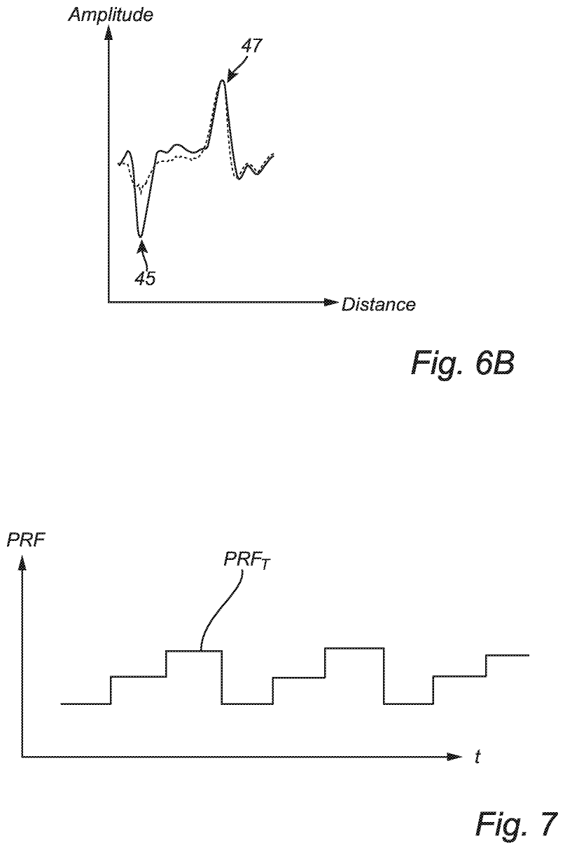

Two example signal disturbance criteria will now be introduced with reference to FIGS. 6A-B, which show two examples of relations between echo curves formed based on undisturbed and disturbed reflection signals.

Referring first to FIG. 6A, a first example of an echo curve (solid line) formed based on a disturbed reflection signal (a disturbed echo curve) is shown together with an echo curve (dashed line) formed based on an undisturbed reflection signal (an undisturbed echo curve). There is a strong negative peak 45 and a strong positive peak 47 in the undisturbed echo curve. The negative peak 45 results from reflection at a reference impedance transition at the feed-through between the outside and the inside of the tank 3, and the positive peak 47 results from reflection at the surface 15 of the product 7 in the tank 3. By comparing the disturbed echo curve with the undisturbed echo curve, it is clear that the peaks of the disturbed echo curve are too narrow, so that about two peaks of the disturbed echo curve fit inside a single peak of the undisturbed echo curve. To distinguish the type of signal disturbance illustrated in FIG. 6A, the signal disturbance criterion may thus include a requirement on the pulse width of peaks in the echo curve. For example, a predefined minimum pulse width may be comprised in the signal disturbance criterion.

Turning then to FIG. 6B, a second example of an echo curve (solid line) formed based on a disturbed reflection signal (a disturbed echo curve) is shown together with an echo curve (dashed line) formed based on an undisturbed reflection signal (an undisturbed echo curve). Like in FIG. 6A, there is a strong negative peak 45 and a strong positive peak 47 in the undisturbed echo curve. The negative peak 45 results from reflection at a reference impedance transition at the feed-through between the outside and the inside of the tank 3, and the positive peak 47 results from reflection at the surface 15 of the product 7 in the tank 3. By comparing the disturbed echo curve with the undisturbed echo curve, it is clear that the amplitude of at least the first peak 45 of the disturbed echo curve is much lower than expected (much lower than the amplitude of the corresponding peak of the undisturbed echo curve). Depending on the signal disturbance affecting the measurement, one or several peaks may instead be far too high. To distinguish the type of signal disturbance illustrated in FIG. 6B, the signal disturbance criterion may thus include a requirement on the relation between measured and expected pulse amplitudes in the echo curve. For example, a predefined minimum (absolute and/or relative) pulse amplitude may be comprised in the signal disturbance criterion.

Returning to the flow-chart in FIG. 4, the method proceeds in different paths depending on the result of the evaluation carried out in step 105. If the signal disturbance criterion is determined to be fulfilled, the method proceeds to step 106, where the filling level L is determined based on at least one reflection signal S_{R} fulfilling the signal disturbance criterion. This filling level determination may be determined based on a direct correlation between the transmit signal S_{T} and the reflection signal S_{R}, or using the (undisturbed) echo curve, where the filling level L can be determined based on the distance to the surface reflection peak 47 and a known arrangement of the radar level gauge system 1 at the tank 3.

After having determined the filling level L, the method proceeds to change the transmit pulse repetition frequency PRF_{T} in step 107, and then the method returns to step 100. If the signal disturbance criterion is instead determined to not be fulfilled in step 105, the method proceeds to change the transmit pulse repetition frequency PRF_{T} in step 108, and then the method returns to step 100.

Various schemes for changing the transmit pulse repetition frequency PRF_{T} between measurement operations may be used, involving few or many different pulse repetition frequencies, different frequency steps, and different durations (for example in terms of number of sweeps). An example scheme for changing the transmit pulse repetition frequency is schematically shown in FIG. 7, where it can be seen that the PRF_{T} is cycled through three different PRFs, with one measurement sweep per PRF and a relative difference between adjacent PRFs of about 10%.

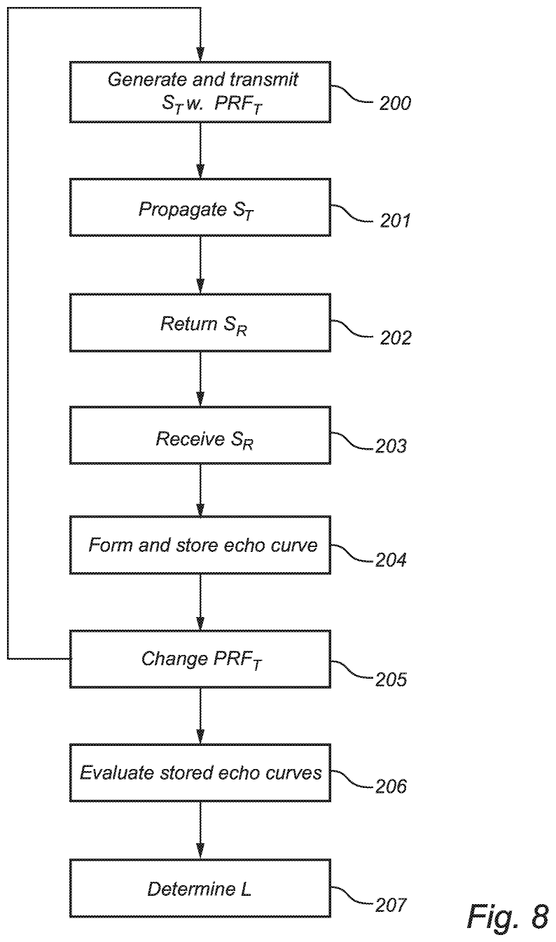

Finally, referring to the flow-chart in FIG. 8, other embodiments of the method according to the present invention will be described. The following description focuses on differences in relation to embodiments described above.

As can be seen in FIG. 8, steps 200-203 correspond to steps 100-103 in FIG. 4. In the subsequent step 204, an echo curve or similar representation is formed and stored based on the reflection signal S_{R}. The echo curve may be formed using, for example, the time-expansion techniques described above on relation to FIG. 4. Thereafter, the transmit pulse repetition frequency PRF_{T} is changed in step 205, and the method goes back to step 200. However, the method also proceeds to step 206 to evaluate the stored echo curves in respect of a predefined signal disturbance criterion as described above. Finally, the filling level is determined, in step 207, based on one or more echo curves fulfilling the signal disturbance criterion.

The person skilled in the art realizes that the present invention by no means is limited to the preferred embodiments described above. On the contrary, many modifications and variations are possible within the scope of the appended claims.

What is claimed is:

1. A method of determining a filling level of a product in a tank using a radar level gauge system including a transceiver, a signal propagation device and processing circuitry, the method comprising the steps of:
performing, for each transmit pulse repetition frequency in a sequence of different transmit pulse repetition frequencies, a measurement operation including:
generating and transmitting an electromagnetic transmit signal in the form of a pulse train of transmit pulses, the pulse train exhibiting the transmit pulse repetition frequency;
propagating the transmit signal towards a surface of the product in the tank;
returning an electromagnetic reflection signal resulting from reflection of the transmit signal at the surface back towards the transceiver; and
receiving the reflection signal; and
determining, for each measurement operation, a measure indicative of signal disturbance of the reflection signal received in the measurement operation;
evaluating, for each measurement operation, the measure indicative of signal disturbance of the reflection signal in view of a predefined signal disturbance criterion; and
determining the filling level based on at least one of the reflection signals fulfilling the signal disturbance criterion.

2. The method according to claim 1, wherein the sequence of different pulse repetition frequencies includes at least three different pulse repetition frequencies.

3. The method according to claim 1, wherein each measurement operation comprises:
generating a pulsed reference signal having a reference pulse repetition frequency.

4. The method according to claim 3, wherein the reference pulse repetition frequency is different for different measurement operations.

5. The method according to claim 4, wherein a difference between the transmit pulse repetition frequency and the reference pulse repetition frequency is substantially the same for each of the measurement operations.

6. The method according to claim 3, wherein each measurement operation comprises:
time-correlating the reference signal and the reflection signal to form a measurement signal.

7. The method according to claim 6, wherein the measure indicative of signal disturbance of the reflection signal received in the measurement operation is determined based on the measurement signal formed in the measurement operation.

8. The method according to claim 1, comprising:
disregarding any reflection signal that fails to fulfill the signal disturbance criterion; and
determining the filling level based on at least one remaining reflection signal.

9. A radar level gauge system for determining the filling level of a product in a tank, comprising:
a transceiver for generating, transmitting and receiving electromagnetic signals;
a propagation device coupled to the transceiver for propagating an electromagnetic transmit signal from the transceiver towards a surface of the product in the tank, and returning an electromagnetic reflection signal resulting from reflection of the transmit signal at the surface of the product; and
processing circuitry coupled to the transceiver, and configured to:
control the transceiver to perform, for each transmit pulse repetition frequency in a sequence of different transmit pulse repetition frequencies, a measurement operation including:
generating and transmitting the transmit signal in the form of a pulse train of transmit pulses, the pulse train exhibiting the transmit pulse repetition frequency; and
receiving the reflection signal;
determine, for each measurement operation, a measure indicative of signal disturbance of the reflection signal received in the measurement operation;
evaluate, for each measurement operation, the measure indicative of signal disturbance of the reflection signal in view of a predefined signal disturbance criterion; and
determine the filling level based on at least one of the reflection signals fulfilling the signal disturbance criterion.

10. The radar level gauge system according to claim 9, wherein the processing circuitry is further configured to control the transceiver to generate a pulsed reference signal having a reference pulse repetition frequency that is different for different measurement operations.

11. The radar level gauge system according to claim 10, wherein a difference between the transmit pulse repetition frequency and the reference pulse repetition frequency is substantially the same for each of the measurement operations.

12. The radar level gauge system according to claim 10, wherein the transceiver comprises a signal correlator configured to time-correlate the reference signal and the reflection signal to form a measurement signal.

13. The radar level gauge system according to claim 12, wherein the processing circuitry is configured to determine the measure indicative of signal disturbance of the reflection signal based on the measurement signal formed by the signal correlator comprised in the transceiver.

14. The radar level gauge system according to claim 9, wherein the processing circuitry is configured to:
disregard any reflection signal that fails to fulfill the signal disturbance criterion; and
determine the filling level based on at least one remaining reflection signal.

15. The radar level gauge system according to claim 9, wherein the transceiver comprises a PLL controllable to generate signals having the transmit pulse repetition frequency.
